(19) United States
(12) Patent Application Publication
(10) Pub. No.: US 2023/0093098 A1
(43) Pub. Date: Mar. 23, 2023

(54) BATTERY

(71) Applicant: Panasonic Intellectual Property Management Co., Ltd., Osaka (JP)

(72) Inventor: SEIJI NISHIYAMA, Osaka (JP)

(21) Appl. No.: 18/052,571

(22) Filed: Nov. 4, 2022

Related U.S. Application Data
(63) Continuation of application No. PCT/JP2021/016250, filed on Apr. 22, 2021.

(30) Foreign Application Priority Data
May 19, 2020 (JP) 2020-087613

(51) Int. Cl. H01M 50/593; H01M 10/04

(52) U.S. Cl. CPC H01M 50/593; H01M 10/049

(57) ABSTRACT

A battery includes: a power generating element including a positive electrode layer, a negative electrode layer, and a solid electrolyte layer between the positive electrode layer and the negative electrode layer; a structure located above a first main surface of the power generating element and having insulating properties; and a laminate film accommodating the power generating element and the structure, wherein a gap is located between the first main surface and the laminate film such that the gap is in contact with the structure.

### BACKGROUND

### 1. Technical Field

The present disclosure relates to a battery.

### 2. Description of the Related Art

Batteries, such as lithium-ion secondary batteries, are used as vehicle batteries. Vehicle batteries are required to have a large capacity as well as high safety, a light weight, and a small size.

Batteries known in the related art, such as lithium-ion secondary batteries including organic electrolyte solutions, have a risk of firing, explosion, and ignition caused by liquid leakage. Therefore, all-solid-state secondary batteries (hereinafter referred to as all-solid-state batteries) have attracted many attentions because solid electrolytes are used instead of organic electrolyte solutions for the purpose of improving safety.

In the related art, a vehicle battery accommodated in a metal can (outer case) composed of a metal plate has been in the mainstream. To reduce weight and size, the use of a laminate film composed of metal foil and resin as an outer case has been studied.

Japanese Patent No. 5648747 discloses an all-solid-state battery in which a power generating element is accommodated in a laminate film. Japanese Unexamined Patent Application Publication No. 2019-57436 discloses a battery in which a power generating element and a pair of housings each having side walls extending in the thickness direction of the power generating element are accommodated in a laminate film.

### SUMMARY

It has been difficult to peel a laminate film off safely and efficiently from batteries known in the related art. One non-limiting and exemplary embodiment provides a battery from which a laminate film is peeled off safely and efficiently.

In one general aspect, the techniques disclosed here feature a battery including: a power generating element including a positive electrode layer, a negative electrode layer, and a solid electrolyte layer between the positive electrode layer and the negative electrode layer; a structure located above a first main surface of the power generating element and having insulating properties; and a laminate film accommodating the power generating element and the structure, wherein a gap is located between the first main surface and the laminate film such that the gap is in contact with the structure.

According to the present disclosure, a battery from which a laminate film is peeled off safely and efficiently can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a plan view of a battery according to a first embodiment;

FIG. 2 is a cross-sectional view illustrating the cross section of the battery taken along line II-II in FIG. 1;

FIG. 3 is a cross-sectional view for describing the relationship of a power generating element and a plurality of structures with the tensile elongation of a laminate film in the battery according to the first embodiment;

FIG. 4 is a cross-sectional view illustrating the cross section of the battery taken along line IV-IV in FIG. 1;

FIG. 5 is a cross-sectional view for describing one example of the relationship of a power generating element and a plurality of structures with the tensile elongation of a laminate film in the battery according to Modification 1 of the first embodiment;

FIG. 6 is a cross-sectional view for describing another example of the relationship of the power generating element and the plurality of structures with the tensile elongation of the laminate film in the battery according to Modification 1 of the first embodiment;

FIG. 7 is a plan view of a battery according to Modification 2 of the first embodiment; and

FIG. 8 is a cross-sectional view of a battery according to a second embodiment.

### DETAILED DESCRIPTIONS

### Underlying Knowledge Forming Basis of the Present Disclosure

The inventor of the present disclosure has found that a battery, particularly an all-solid-state battery, faces the following problem when an outer case, such as a laminate film, is sealed.

The sealing process in a battery production method known in the related art needs to involve removing moisture in a laminate film as much as possible, minimizing the volume of a battery, and furthermore bringing an outer case into close contact with a power generating element. In the sealing process, a power generating element is enclosed in a laminate film under vacuum, and the laminate film enclosing the power generating element is sealed by hot pressing. When the laminate film including the power generating element is placed under atmospheric pressure after being sealed, the laminate film comes into close contact with the power generating element because of a difference between the pressure in the laminate film and the atmospheric pressure.

A battery known in the related art is repeatedly charged and discharged during use while a laminate film is in close contact with a power generating element. If a battery cannot be adequately charged and discharged during use, the battery is discarded. Before discarding, the laminate film needs to be peeled off from the power generating element.

Since the laminate film is in close contact with the power generating element because of a difference between the pressure in the laminate film and the atmospheric pressure, however, electric sparks may be generated by peeling electrification or triboelectrification caused when the laminate film is peeled off. In this case, there is a risk of delay in separation work, injury to workers in separation work, or firing in dry conditions.

In other words, a battery known in the related art has a problem of low safety at the time of peeling the laminate film off, such as discarding the battery, because the laminate film is in close contact with the power generating element under atmospheric pressure after the laminate film sealing process under vacuum.

Furthermore, a battery known in the related art has a problem of difficulty and inefficiency in peeling the laminate film off from the power generating element since the laminate film is in close contact with the power generating element.

In light of the foregoing problems, the present disclosure is directed to a battery from which a laminate film is peeled off safely and efficiently.

The overview of one aspect of the present disclosure is as described below.

A battery according to one aspect of the present disclosure includes: a power generating element including a positive electrode layer, a negative electrode layer, and a solid electrolyte layer between the positive electrode layer and the negative electrode layer; a structure located above a first main surface of the power generating element and having insulating properties; and a laminate film accommodating the power generating element and the structure, wherein a gap is located between the first main surface and the laminate film such that the gap is in contact with the structure.

Since the laminate film is not in close contact with the power generating element in a region where the gap is located, peeling electrification or triboelectrification is unlikely to occur at the time of peeling the laminate film off. Therefore, the laminate film is safely peeled off from the battery.

When part of the gap is opened to the atmosphere at the time of peeling the laminate film off from the power generating element, the atmosphere enters the gap, and the pressure of the entire gap becomes equal to atmospheric pressure. The atmospheric pressure of the atmosphere entering the gap presses the laminate film, and the laminate film and the power generating element are easily released from close contact with each other made under atmospheric pressure. As a result, the battery in which the laminate film is efficiently peeled off from the power generating element is realized.

In summary, the battery from which a laminate film is peeled off safely and efficiently can be provided.

For example, the battery according to one aspect of the present disclosure may include a plurality of the structures, and the gap may be located between adjacent two of the structures.

This configuration results in a wider region where the gap is located. In other words, the laminate film is not in close contact with the power generating element in a wider region where the gap is located, and thus peeling electrification or triboelectrification is less likely to occur at the time of peeling the laminate film off. Therefore, the battery from which the laminate film is more safely peeled off is realized.

For example, each of the plurality of structures may have a rectangular parallelepiped shape.

With this configuration, the laminate film is in contact with, for example, one face of the rectangular parallelepiped of each of the structures. Thus, an excessive pressure is less likely to act on parts where the laminate film is in contact with the structures when the laminate film is sealed, which prevents breakage of the laminate film. In other words, the battery with high reliability is realized.

For examples, each of the structures may have a convex surface protruding toward the laminate film,

With this configuration, the laminate film is in contact with, for example, the convex surface of each of the structures. Thus, an excessive pressure is less likely to act on parts where the laminate film is in contact with the structures when the laminate film is sealed, which prevents breakage of the laminate film. In other words, the battery with high reliability is realized.

For examples, the structures may be arranged in a matrix in the plan view of the power generating element.

With this configuration, portions of the gap between adjacent two structures are connected to each other to form a grid pattern in plan view. When part of the gap is opened to the atmosphere at the time of peeling the laminate film off from the power generating element, the pressure in a wider range of the grid pattern becomes equal to atmospheric pressure. As a result, the laminate film is efficiently peeled off from the power generating element.

For examples, the structures may be spaced apart from each other and arranged in a stripe pattern.

When the structures are arranged in a stripe pattern, the gap is also arranged so as to extend in a stripe pattern. When part of the gap is opened to the atmosphere at the time of peeling the laminate film off from the power generating element, the pressure in a wider range of the stripe pattern becomes equal to atmospheric pressure. As a result, the laminate film is efficiently peeled off from the power generating element.

For example, the battery according to one aspect of the present disclosure may satisfy

$$\begin{matrix}[ Math . 1 ] & \\ X > L \times ( 1 + ( \frac{\begin{matrix}E & \begin{matrix}l & l\end{matrix}\end{matrix}}{\begin{matrix}1 & \begin{matrix}0 & 0\end{matrix}\end{matrix}} ) ) & Formula ( 1 )\end{matrix}$$

where X is the creepage distance that is the length along the first main surface and the surfaces of the structures in a direction parallel to the first main surface, L is the length of the power generating element in the above direction, and Elf is the tensile elongation of the laminate film.

Even when the laminate film is placed under atmospheric pressure after being sealed, the laminate film is in close contact with the structures, but part of the laminate film is unlikely to be in close contact with the power generating element because of the gap between the first main surface and the laminate film. In other words, the gap formed between adjacent two structures allows the laminate film to be peeled off more safely and efficiently from the battery having the power generating element enclosed in the laminate film.

For example, the solid electrolyte layer may be a solid electrolyte layer containing a solid electrolyte having lithium-ion conductivity.

The laminate film is thus peeled off safely and efficiently from the battery containing the solid electrolyte having lithium-ion conductivity.

For example, the battery according to one aspect of the present disclosure may further include a plurality of structures on a second main surface of the power generating element opposite to the first main surface,

Accordingly, a gap is provided on each of the first main surface and the second main surface. Therefore, the battery from which the laminate film is peeled off more safely and more efficiently can be provided.

Embodiments will be described below with reference to the drawings.

Any embodiment described below illustrates comprehensive or specific examples. The values, shapes, materials, components, the arrangement positions and connection configuration of the components, production processes, the sequence of production processes, and the like described in the following embodiments are illustrative only and should not be construed as limiting the present disclosure Among the components in the following embodiments, the components that are not mentioned in the independent claims are described as optional components.

The drawings are all schematic views and are not necessarily accurately drawn. Therefore, for example, the drawings are not necessarily drawn to scale. In the drawings, components having substantially the same function are denoted by the same reference characters, and the redundant description thereof is omitted or simplified.

In this specification, the terms expressing the relationship between elements, such as parallel or perpendicular, the terms expressing the shapes of elements, such as rectangle or circle, and the numerical ranges are not expressions having only strict meanings but expressions having meanings in a substantially equivalent range, for example, including a difference of about several percentages,

The “in plan view” in this specification refers to the case of viewing the power generating element in plan view, namely, the case of viewing the battery in the laminating direction of the battery. The figure at this time is a plan view.

In this specification, the terms “upper” and “lower” regarding the structure of the battery do not refer to a higher position (vertically above) and a lower position (vertically below) in absolute space recognition but are used as terms defined by the relative positional relationship based on the laminating order in the multilayer structure. The terms “above” and “below” are used not only when two components are spaced apart from each other with another component therebetween, but also when two components are disposed, in close contact with each other so that they touch each other.

In this specification and the drawings, the x-axis, y-axis, and z-axis represent three axes in a three-dimensional cartesian coordinate system. In each embodiment, the first main surface of the power generating element is parallel to the xy-plane, and the direction perpendicular to the xy-plane is the z-axis direction. In each embodiment described below, the positive z-axis direction is described as upper, and the negative z-axis direction is described as lower.

### First Embodiment

### 1. Overview of Battery

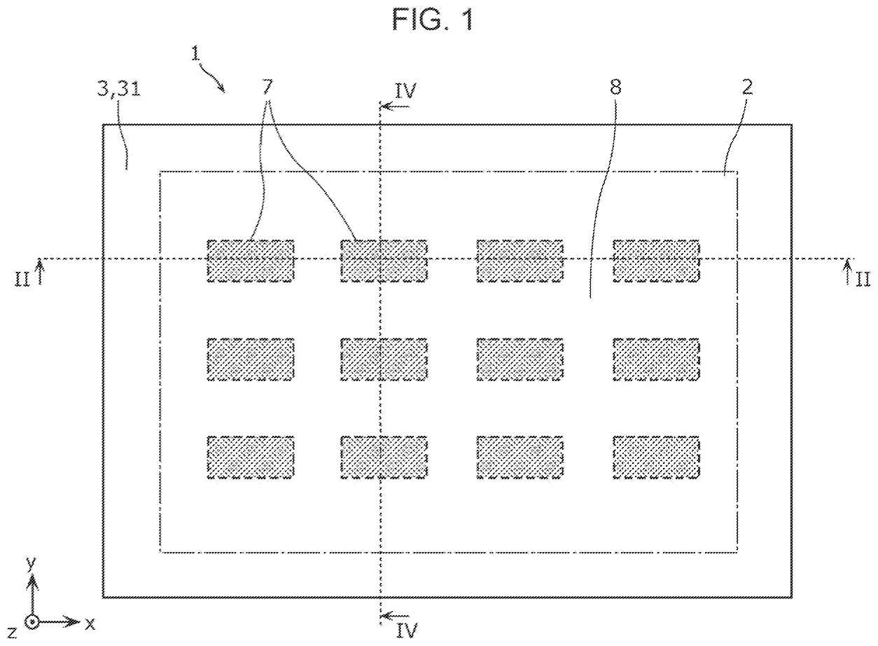

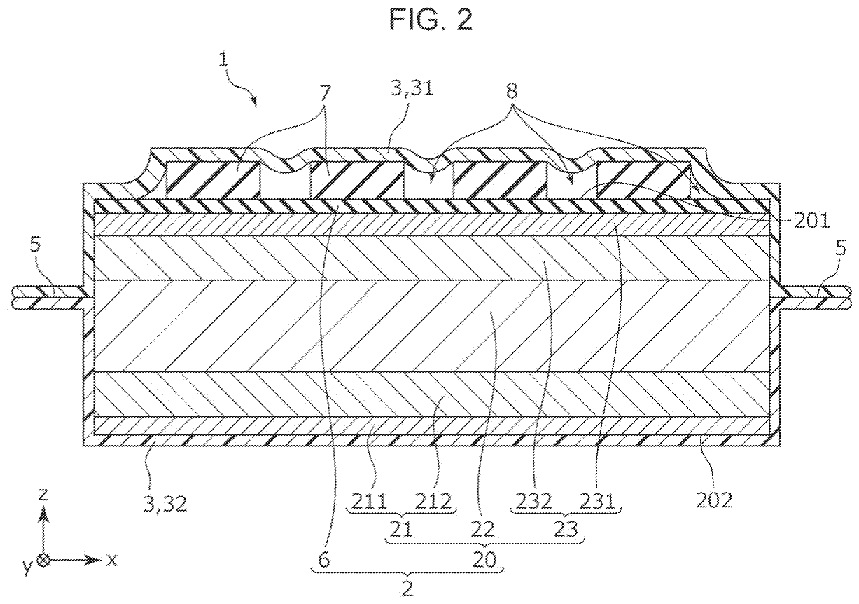

First, the overview of a battery according to a first embodiment will be described with reference to FIG. 1 and FIG. 2. FIG. 1 is a plan view of a battery 1 according to the first embodiment, FIG. 2 is a cross-sectional view illustrating the cross section of the battery 1 taken along line II-II in FIG. 1.

Referring to FIG. 1 and FIG. 2, the battery 1 includes a power generating element 2, a laminate film 3, and a plurality of structures 7. in the battery 1, the power generating element 2 and the structures 7 are accommodated in the laminate film 3, and the laminate film 3 is sealed. The laminate film 3 has a first laminate film 31, a second laminate film 32, and a sealing part 5.

The structures 7 are located above a first main surface 201 of the power generating element 2, more specifically located between the first laminate film 31 and the power generating element 2. In FIG. 1, the structures 7 are filled with dots. The upper sides of the structures 7 are in contact with the first laminate film 31. A gap 8 is located between the first main surface 201 and the first laminate film 31 such that the gap 8 is in contact with the structures 7. In this embodiment, the gap 8 is located between the structures 7.

Since the first laminate film 31 is not in close contact with the power generating element 2 in a region where the gap 8 is located, peeling electrification or triboelectrification is unlikely to occur when the first laminate film 31 is peeled off. The battery 1 from which the first laminate film 31 is safely peeled off is realized accordingly.

When part of the gap 8 is opened to the atmosphere at the time of peeling the first laminate film 31 off from the power generating element 2, the atmosphere enters the gap 8, and the pressure of the entire gap 8 becomes equal to atmospheric pressure. The atmospheric pressure of the atmosphere entering the gap 8 presses the first laminate film 31 in a direction away from the power generating element 2, and the first laminate film 31 and the power generating element 2 are easily released from close contact with each other made under atmospheric pressure. As a result, the first laminate film 31 is efficiently peeled off from the power generating element 2.

In summary, the battery 1 from which the first laminate film 31 is peeled off safely and efficiently is realized.

### 2. Structure

Next, the structure of the battery 1 according to this embodiment will be described in more detail. Referring to FIG. 2, the battery 1 according to this embodiment includes: the power generating element 2 including the protective plate 6 and a multilayer body including a positive electrode layer, a negative electrode layer, and a solid electrolyte layer; a laminate film 3; and the plurality of structures 7. The battery 1 is, for example, an all-solid-state battery.

First, the power generating element 2 will be described.

The power generating element 2 includes at least one battery cell 20 and the protective plate 6.

The battery cell 20 includes a positive electrode layer, a solid electrolyte layer, and a negative electrode layer laminated in this order. In this embodiment, the power generating element 2 includes only one battery cell. The battery cell 20 includes a first electrode layer 21, a second electrode layer 23, and a solid electrolyte layer 22. The first electrode layer 21 includes a first current collector 211 and a first active material layer 212. The first active material layer 212 is located between the first current collector 211 and the solid electrolyte layer 22. The second electrode layer 23 includes a second current collector 231 and a second active material layer 232. The second active material layer 232 is located between the second current collector 231 and the solid electrolyte layer 22,

Hereinafter, an example in which the first electrode layer 21 is a positive electrode layer and the second electrode layer 23 is a negative electrode layer will be described. In other words, the first current collector 211 is a positive electrode current collector, and the first active material layer 212 is a positive electrode active material layer. The second current collector 231 is a negative electrode current collector, and the second active material layer 232 is a negative electrode active material layer. In other words, in this embodiment, the battery cell 20 includes a positive electrode current collector, a positive electrode active material layer, a solid electrolyte layer, a negative electrode active material layer, and a negative electrode current collector laminated in this order.

The first electrode layer 21 may be a negative electrode layer, and the second electrode layer 23 may be a positive electrode layer. In other words, the first current collector 2.1.1 may be a negative electrode current collector, and the first active material layer 212 may contain a negative electrode active material. The second current collector 231 may be a positive electrode current collector, and the second active material layer 232 may contain a positive electrode active material.

The first current collector 211, the first active material layer 212, the solid electrolyte layer 22, the second active material layer 232, and the second current collector 231 each have a rectangular shape in plan view. The plan view shape of each of the first current collector 211, the first active material layer 212, the solid electrolyte layer 22, the second active material layer 232, and the second current collector 231 is not limited and may be a square or a shape other than a rectangle, such as a circle, an oval, or a polygon. In other words, the battery cell 20 formed by laminating the first current collector 211, the first active material layer 212, the solid electrolyte layer 22, the second active material layer 232, and the second current collector 231 has the same shape as described above.

In this embodiment, the rectangular battery cell 20 has, for example, a length greater than or equal to 10 (mm) and less than or equal to 1000 (mm) in the x-axis direction, a length greater than or equal to 10 (mm) and less than or equal to 1000 (mm) in the y-axis direction, and a thickness (length in z-axis direction) greater than or equal to 1 (mm) and less than or equal to 100 (mm). However, the size of the battery cell 20 is not limited to the above size.

In this embodiment, the first current collector 211, the first active material layer 212, the solid electrolyte layer 22, the second active material layer 232, and the second current collector 231 have the same size, and the contours of these components coincide with each other in plan view. However, the present disclosure is not limited to this configuration. For example, the first active material layer 212 may be smaller than the second active material layer 232. The first active material layer 212 and the second active material layer 232 may be smaller than the solid electrolyte layer 22.

The first current collector 211 and the second current collector 231 may be made of a known conductive material. The first current collector 211 and the second current collector 231 are composed of, for example, a foil, plate, or mesh made of, for example, copper, aluminum, nickel, iron, stainless steel, platinum, or gold, or an alloy of two or more of these metals.

The first active material layer 212, which is a positive electrode active material layer, contains at least a positive electrode active material. The first active material layer 212 may contain at least one of a solid electrolyte, a conductive assistant, or a binding agent (i.e., binder) as necessary.

The positive electrode active material may be a known material capable of accepting and releasing (intercalating and deintercalating or dissolving and depositing) lithium ions, sodium ions, or magnesium ions. When the positive electrode active material is a material capable of intercalating and deintercalating lithium ions, the positive electrode active material is, for example, lithium cobalt oxide composite oxide (LCO), lithium nickel oxide composite oxide (LNO), lithium manganese oxide composite oxide (LMO), lithium-manganese-nickel composite oxide (LMNO), lithium-manganese-cobalt composite oxide (LMCO), lithium-nickel-cobalt composite oxide (LNCO), or lithium-nickel-manganese-cobalt composite oxide (LNMCO).

The solid electrolyte may be a known material, such as a lithium ion conductor, a sodium ion conductor, or a magnesium ion conductor. The solid electrolyte may be either an inorganic solid electrolyte or a polymer solid electrolyte (including a gel solid electrolyte). The inorganic solid electrolyte is, for example, a sulfide solid electrolyte or an oxide solid electrolyte.

When the sulfide solid electrolyte is a lithium ion-conducting material, the sulfide solid electrolyte is, for example, a synthetic product composed of lithium sulfide (Li₂S) and phosphorus pentasulfide (P₂S₅). The sulfide solid electrolyte may be a sulfide, such as Li₂S—SiS₂, Li₂S-B₂S₃, or Li₂S—GeS₂. Alternatively, the sulfide solid electrolyte may be a sulfide formed by adding at least one of Li₃N, LiCl, LiBr, Li₃PO₄, or Li₄SiO₄ to the above sulfide as an additive.

When the oxide solid electrolyte is a lithium ion-conducting material, the oxide solid electrolyte is, for example, Li₇La₃Zr₂O₁₂ (LLZ), Li_{1.3}Al_{0.3}Ti_{1.7}(PO₄)₃ (LATP), or (La,Li)TiO₃ (LLTO).

The conductive assistant is, for example, a conductive material, such as acetylene black, carbon black, graphite, or carbon fiber. The binding agent is, for example, a binder for binding, such as polyvinylidene fluoride.

The second active material layer 232, which is a negative electrode active material layer, contains at least a negative electrode active material. Like the positive electrode active material layer, the second active material layer 232 may contain at least one of a solid electrolyte, a conductive assistant, or a binding agent (binder) as necessary.

The negative electrode active material may be a known material capable of accepting and releasing (intercalating and deintercalating or dissolving and depositing) lithium ions, sodium ions, or magnesium ions. When the negative electrode active material is a material capable of intercalating and deintercalating lithium ions, the negative electrode active material is, for example, a carbon material, such as natural graphite, artificial graphite, graphite carbon fiber, or resin heat-treated carbon, metal lithium, a lithium alloy, or a lithium transition metal oxide.

The solid electrolyte layer 22 contains at least a solid electrolyte. The solid electrolyte layer 22 may contain a binding agent as necessary. The solid electrolyte layer 22 may contain a solid electrolyte having lithium-ion conductivity. The solid electrolyte and the binding agent in the solid electrolyte layer 22 may be the solid electrolyte and the binding agent described above.

The protective plate 6 is a protective member for preventing deformation and breakage of the battery cell 20. The protective plate 6 may be composed of a more rigid member than the battery cell 20, The material of the protective plate 6 is, for example, a conductive material, such as metal, or an insulating material, such as ceramic or resin. To facilitate shape processing, the material of the protective plate 6 may be a conductive material, such as metal. When the material of the protective plate 6 is a conductive material, such as metal, the protective plate 6 is electrically insulated from the battery cell 20 such that, for example, the protective plate 6 and the battery cell 20 are separated from each other with an insulating member, or the protective plate 6 or the battery cell 20 is covered by an insulating layer.

The protective plate 6 is located so as to cover the entire upper surface of the battery cell 20. More specifically, the upper surface of the battery cell 20 is one surface of the second current collector 231 and is a surface opposite to the surface in contact with the second active material layer 232. As illustrated in FIG. 1, the protective plate 6 has a rectangular shape in plan view. The plan view shape of the protective plate 6 is not limited and may be a square or a shape other than a rectangle, such as a circle, an oval, or a polygon, according to the shape of the battery cell 20. The size of the protective plate 6 may be equivalent or similar to the size of the battery cell 20, but the present disclosure is not limited to this size. The protective plate 6 may be smaller or larger than the battery cell 20.

The shape of the protective plate 6 is not limited to the above shapes. The protective plate 6 may be shaped so as to cover two or more of six surfaces of the battery cell 20 having a rectangular parallelepiped shape. For example, when the protective plate 6 covers all six surfaces of the battery cell 20, the protective plate 6 functions as a housing for protecting the battery cell 20.

In this embodiment, the first main surface 201 of the power generating element 2 is the upper surface of the protective plate 6. More specifically, the first main surface 201 is one surface of the protective plate 6 and is a surface opposite to the surface in contact with the second current collector 231. A second main surface 202 of the power generating element 2 is a surface opposite to the first main surface 201 and is one surface of the first current collector 211. More specifically, the second main surface 202 is one surface of the first current collector 211 and is a surface opposite to the surface in contact with the first active material layer 212.

The power generating element 2 may not have the protective plate 6. In this case, the battery cell 20 can be prevented from breaking by increasing the thickness of the first current collector 211 and the thickness of the second current collector 231. In this case, the first main surface 201 is one surface of the second current collector 231 and is a surface opposite to the surface in contact with the second active material layer 232.

The power generating element 2 may have a plurality of laminated battery cells 20. The battery cells 20 may be laminated in any configuration as long as they function as a battery. For example, the battery cells 20 are laminated so as to be electrically connected in series or in parallel. The number of battery cells 20 in the power generating element 2 may be two, or may be greater or equal to three. The number of battery cells 20 is not limited.

The battery cells 20 may be such that adjacent battery cells 20 share a positive electrode current collector or a negative electrode current collector. Specifically, the positive electrode layer or the negative electrode layer in one battery cell 20 may not include a current collector or may include a positive electrode active material layer or negative electrode active material layer on the current collector of the adjacent battery cell 20. In the battery cells 20, the side surfaces of each layer may be covered by a sealing member made of, for example, a resin for sealing.

Next, the laminate film 3 including the first and second laminate films 31 and 32 will be described.

The laminate film 3 is an outer case that accommodates the power generating element 2 and a plurality of structures 7 and that has a film shape with flexibility. The laminate film 3 covers the surfaces of the power generating element 2 and the structures 7 and protects the power generating element 2 from water and air. The laminate film 3 includes the first laminate film 31, the second laminate film 32, and the sealing part 5 in which the first laminate film 31 and the second laminate film 32 are attached to each other.

For example, when the pressure of the space outside the laminate film 3 increases to atmospheric pressure after the laminate film 3 covers and accommodates the power generating element 2 and the structures 7 under vacuum, the laminate film 3 is stretched to come into close contact with the second main surface 202 and two side surfaces of the power generating element 2. However, when the structures 7 described below are located on the first main surface 201, the laminate film 3 (more specifically, first laminate film 31) is in close contact with the upper surface of each of the structures 7 but not in close contact with the entire first main surface 201, and the gap 8 is formed.

The laminate film 3 is a film having a multilayer structure including a resin layer made of a resin, such as a polyethylene resin or a polypropylene resin, and a metal layer made of a metal such as aluminum. The laminate film 3 may be a known laminate film. The laminate film 3 has, for example, a three-layer structure including a resin layer, a metal layer, and a resin layer laminated in this order. The laminate film 3 has, for example, a three-layer structure including a polyester layer 50 (μm), an aluminum layer 25 (μm), and a polyester layer 50 (μm) and has a thickness of 125 (μm). The number of laminate films 3 is not limited to three and may be selected according to the intended purpose,

The sealing part 5 is a part in which a peripheral portion of the first laminate film 31 and a peripheral portion of the second laminate film 32 are attached to each other. In this embodiment, an outer peripheral portion of the first laminate film 31 and an outer peripheral portion of the second laminate film 32 are brought into close contact with each other and sealed to form the sealing part 5. The sealing part 5 has, for example, a loop shape so as to surround the power generating element 2 in plan view.

The laminate film 3 may be formed by bending one laminate film. Specifically, part of one laminate film may be the first laminate film 31, and the other part may be the second laminate film 32.

The laminate film 3 may have a thickness greater than or equal to 100 (μm) and less than or equal to 1000 (μm). The tensile elongation of the laminate film 3 is measured in accordance with JIS-C-2151 and ASTM-D-882. The tensile elongation of the laminate film 3 may be greater than or equal to 20(%) and less than or equal to 200(%).

The laminate film 3 configured as described above is an outer case having high flexibility and functioning as a barrier to air and water.

The structures 7 are members located above the first main surface 201 of the power generating element 2. More specifically, the structures 7 are located between the first main surface 201 and the first laminate film 31 and disposed in contact with the first main surface 201 and the first laminate film 31. In other words, the structures 7 are in contact with the second current collector 231 with the protective plate 6 therebetween.

Each of the structures 7 may be shaped so as to be in contact with and along the first main surface 201. As illustrated in FIG. 1, the plan view shape of each of the structures 7 is rectangular, and the shape of each of the structures 7 in this case is, for example, a rectangular parallelepiped but may be another shape. When the shape of each of the structures 7 is a. rectangular parallelepiped, the first laminate film 31 is in contact with one face (upper surface in this case) of the rectangular parallelepiped of each of the structures 7. Thus, an excessive pressure is less likely to act on parts where the first laminate film 31 is in contact with the structures 7 when the laminate film 3 is sealed, which prevents breakage of the first laminate film 31. In other words, the battery 1 with high reliability is realized.

The size of the structures 7 may be such that, for example, one side is greater than or equal to 1 (mm) and less than or equal to 30 (mm). However, the present disclosure is not limited to this configuration. The length of the structures 7 in the height direction (z-axis direction) is preferably larger than the thickness of the laminate film 3.

The structures 7 may be fixed in close contact with the first laminate film 31 and the protective plate 6. For example, an adhesive layer (not shown) or the like may be located between the structures 7 and the first laminate film 31 and between the structures 7 and the protective plate 6. Accordingly, the structures 7 may have, for example, sufficient adhesion and bonding strength to the protective plate 6 and the first laminate film 31.

The structures 7 are arranged in a matrix in plan view, but the present disclosure is not limited to this configuration. For example, the structures 7 may be randomly arranged in plan view. The structures 7 are spaced apart from each other at regular intervals but may be spaced apart from each other at random intervals. The structures 7 may be disposed in the entire region of the first main surface 201 in plan view, but may be disposed in part of the region of the first main surface 201.

In this embodiment, four structures 7 are arranged in the x-axis direction, and three structures 7 are arranged in the y-axis direction. Total 12 structures 7 are arranged in a matrix.

The structures 7 have insulating properties. The structures 7 may be made of an insulating material. The structures 7 may be, for example, made of resin or the like, and the resin is, for example, a polyimide resin. However, the material of the structures 7 is not limited to the above material. For example, the material of the structures 7 may be a metal material, but in this case, the periphery of the structures 7 may be insulated or coated with an insulating material. The structures 7 having insulating properties can prevent electrical defects (e.g., leakage or short circuiting) of the battery 1.

When the laminate film 3 is returned to atmospheric pressure after being sealed, an external force (i.e., force toward power generation element 2) from atmospheric pressure is exerted on the power generating element 2, For this, the structures 7 may be made of a material having hardness, strength, and elasticity sufficient to suppress deformation caused by the external force.

In this embodiment, the protective plate 6 and the structures 7 are different members, but the present disclosure is not limited to this. The protective plate 6 and the structures 7 may be made of the same material and may be integrated into a single member by using a mold or the like.

The gap 8 is a space in contact with the structures 7 and located between the first main surface 201 and the first laminate film 31. In this embodiment, the gap 8 is a space surrounded by the structures 7, the first main surface 201, and the first laminate film 31. The position of the gap 8 is not limited to the above position. For example, the gap 8 may be located above or below the structures 7, In this case, each of the structures 7 may not have a rectangular parallelepiped shape.

A specific method for producing the battery I will be described below. In the method for producing the battery 1, the laminate film 3 enclosing the power generating element 2 is sealed and then placed under atmospheric pressure. The structures 7 located above the first main surface 201 prevent the first laminate film 31 from completely coming into close contact with the power generating element 2 (more specifically, first main surface 201 of power generating element 2) even when the laminate film 3 is placed under atmospheric pressure. In other words, peeling electrification or triboelectrification is unlikely to occur in a region where the gap 8 is located, The battery 1 from which the first laminate film 31 is safely peeled off is realized accordingly. When part of the gap 8 is opened to the atmosphere at the time of peeling the first laminate film 31 off from the power generating element 2, the atmosphere enters the gap 8, and the first laminate film 31 and the power generating element 2 are easily released from close contact with each other made under atmospheric pressure. As a result, the first laminate film 31 is efficiently peeled off from the power generating element 2. In this embodiment, the battery 1 includes a plurality of the structures 7, but a battery including one structure 7 is expected to have the same operation and effect.

As illustrated in FIG. 1 and FIG. 2, the gap 8 is located between adjacent two of the structures 7. In this embodiment, the first laminate film 31 and the first main surface 201 are not in contact with each other between adjacent two structures 7.

The arrangement of a plurality of the structures 7 results in a wider region where the gap 8 is located. In other words, the first laminate film 31 is not in close contact with the power generating element 2 in a wider region where the gap 8 is located, and thus peeling electrification or triboelectrification is less likely to occur when the first laminate film 31 is peeled off. Therefore, the battery 1 from which the first laminate film 31 is more safely peeled off is realized.

Since the structures 7 are arranged in a matrix in plan view as described above, portions of the gap 8 are connected to each other to form a grid pattern in plan view. In other words, the gap 8 is formed such that spaces extending in the x-axis direction intersect with spaces extending in the y-axis direction.

When part of the gap 8 is opened to the atmosphere at the time of peeling the first laminate film 31 off from the power generating element 2, the atmosphere enters the gap 8, and the pressure of the entire gap 8 becomes equal to atmospheric pressure. The atmospheric pressure of the atmosphere entering the gap 8 presses the first laminate film 31 in a direction away from the power generating element 2, and the first laminate film 31 and the power generating element 2 are easily released from close contact with each other made under atmospheric pressure. With the gap 8 configured in a grid pattern, the pressure in a wider range becomes equal to atmospheric pressure when part of the gap 8 is opened to the atmosphere. As a result, the first laminate film 31 is efficiently peeled off from the power generating element 2.

In this embodiment, the first laminate film 31 and the first main surface 201 are not in contact with each other between adjacent two of the structures 7. However, the present disclosure is not limited to this configuration, and part of the first laminate film 31 may be in contact with part of the first main surface 201.

3. Relationship of Power Generating Element and Structures with Tensile Elongation of Laminate Film

The relationship of the power generating element 2 and a plurality of the structures 7 with the tensile elongation of the laminate film 3 will be described.

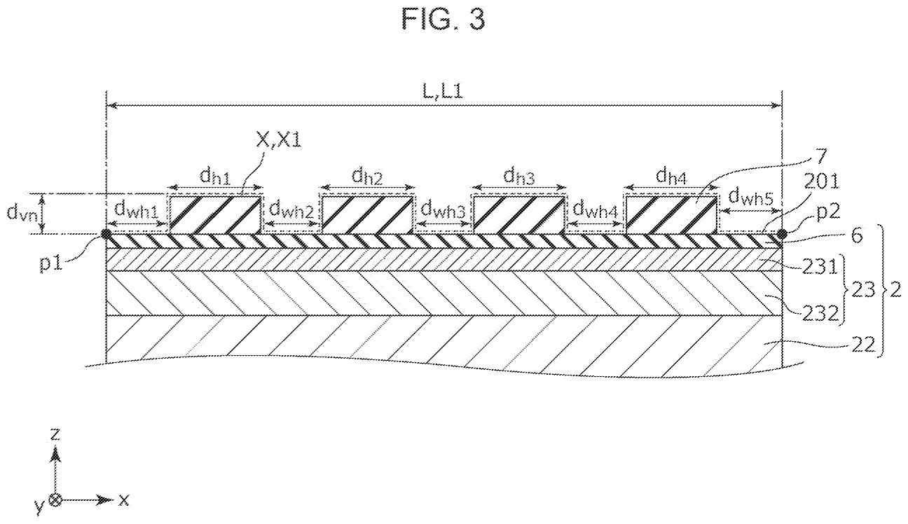

FIG. 3 is a cross-sectional view for describing the relationship of the power generating element 2 and a plurality of the structures 7 with the tensile elongation of the laminate film 3 in the battery 1 according to the first embodiment. More specifically, FIG. 3 is a cross-sectional view in which the laminate film 3 and other elements in FIG. 2 are omitted.

The length along the first main surface 201 and the surfaces of the structures 7 in the direction parallel to the first main surface 201 is defined as a creepage distance X. This direction is any direction along the first main surface 201 (i.e., xy plane) and is, for example, the positive x-axis direction in FIG. 3. In other words, the creepage distance X is the length along the first main surface 201 and the surfaces of the structures 7 in the positive x-axis direction. More specifically, in FIG. 3, the creepage distance X is the length along the broken line and is the length along the first main surface 201 and the surfaces of the structures 7 between a first end p1 of the first main surface 201 and a second end p2 of the first main surface 201.

When the length of the power generating element 2 in the above direction (positive x-axis direction in this case) is denoted by L, and the tensile elongation of the laminate film 3 is denoted by Elf (%), the creepage distance X, the length L, and the tensile elongation Elf satisfy Formula (2).

$$\begin{matrix}[ Math . 2 ] & \\ X > L \times ( 1 + ( \frac{\begin{matrix}E & \begin{matrix}l & f\end{matrix}\end{matrix}}{\begin{matrix}1 & \begin{matrix}0 & 0\end{matrix}\end{matrix}} ) ) & Formula ( 2 )\end{matrix}$$

Even when the laminate film 3 is placed under atmospheric pressure after being sealed, the first laminate film 31 is in close contact with the structures 7, but part of the first laminate film 31 is unlikely to be in close contact with the power generating element 2 because of the gap 8 between adjacent two structures 7. In other words, the gap 8 formed between adjacent two structures 7 allows the first laminate film 31 to be peeled off more safely and efficiently from the battery 1 having the power generating element 2 enclosed in the laminate film 3.

A more specific creepage distance will be described. For description, the creepage distance according to a first example of this embodiment is denoted by XI, and the creepage distance according to a second example is denoted by X2.

First, the creepage distance X1 according to the first example will be described with reference to FIG. 3. The creepage distance X1 is the creepage distance when the direction parallel to the first main surface 201 is the positive x-axis direction as described above.

As illustrated in FIG. 3, the height (length in z-axis direction) of the structures 7 is denoted by dᵥₙ (mm), and the width (length in x-axis direction) is denoted by dₕₙ (mm). The subscript n indicates the order of the structures 7 arranged in the positive x-axis direction.

The width (length in x-axis direction) of regions in which the structures 7 are not located and that are positioned above the first main surface 201 is denoted by d_{whm} (mm). The subscript m indicates the order of the regions arranged in the positive x-axis direction. The length of the power generating element 2 in the positive x-axis direction according to the first example is denoted by L1. In this case, the creepage distance X1 satisfies Formula (3).

[Math. 3]

X1=Σₖ₌₁ⁿ(d_{h k}+2×d_{v k})+Σₖ₌₁^{m}(d_{w h k}) Formula (3)

For example, the length L1 of the power generating element 2 in the positive x-axis direction is 65 (mm), each of dₕₙ is 10 (mm), each of dᵥₙ is 5 (mm), and each of d_{wm} is 5 (mm). Four structures 7 are arranged in the x-axis direction as described above, and the tensile elongation of the laminate film 3 is 20%.

The creepage distance X1 in this case is 105 (mm) because the total dim is 40 (mm), the total d_{vn is} 40 (mm), and the total is 25 (mm). In the first example, the creepage distance X1 is calculated by using Formula (2). X in Formula (2) corresponds to X1, and L corresponds to L1. In this case, the value on the left side is 105 (mm), and the value on the right side is 78 (mm), which satisfies Formula (2). Since the tensile elongation is between 20 (%) and 200 (%) as described above, the size, shape, number, arrangement of the structures 7 are determined so as to satisfy Formula (2).

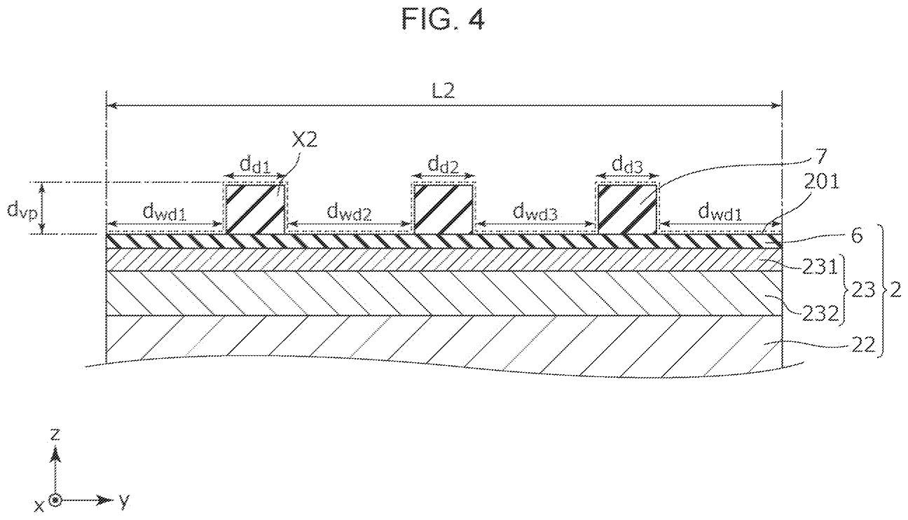

As described above, the direction parallel to the first main surface 201 is not limited to the positive x-axis direction and may be the positive y-axis direction. In the second example, the creepage distance X2 is the creepage distance when the direction parallel to the first main surface 201 is the positive y-axis direction. Next, the creepage distance X2 according to the second example will be described with reference to FIG. 4.

FIG. 4 is a cross-sectional view illustrating the cross section of the battery 1 taken along line IV-IV in FIG. 1. In FIG. 4, the creepage distance X2 is the length along the broken line.

As illustrated in FIG. 4, the height (length in z-axis direction) of the structures 7 is denoted by dᵥₚ (mm), and the width (length in y-axis direction) is denoted by d_{dp} (mm). The subscript p indicates the order of the structures 7 arranged in the positive y-axis direction. The width (length in y-axis direction) of regions in which the structures 7 are not located and that are positioned above the first main surface 201 is denoted by d_{wdq} (mm). The subscript q indicates the order of the regions arranged in the positive y-axis direction. The length of the power generating element 2. in the positive y-axis direction according to the second example is denoted by L2. In this case, the creepage distance X2 satisfies Formula (4).

[Math. 4]

X2=Σₖ₌₁^{p}(d_{d k}+2×d_{v k})+Σₖ₌₁^{q}(d_{w d k}) Formula (4)

For example, the length L2 of the power generating element 2 in the positive y-axis direction is 55 (mm), each of d_{dp} is 5 (mm), each of dᵥₚ is 5 (mm), and each of d_{wdq} is 10 (mm). Three structures 7 are arranged in the y-axis direction as described above, and the tensile elongation of the laminate film 3 is 20%.

The creepage distance X2 in this case is 85 (mm) because the total d_{dp} is 15 (mm), the total dᵥₚ is 30 (mm), and the total d_{wdq} is 40 (mm). In the second example, the creepage distance X2 is calculated by using Formula (2). X in Formula (2) corresponds to X2, and L corresponds to L2. In this case, the value on the left side is 85 (mm), and the value on the right side is 66 (mm), which satisfies Formula (2). The size, shape, number, arrangement of the structures 7 are determined so as to satisfy Formula (2).

The creepage distances X, X1, and X2 were measured with an optical profilometer. Steps greater or equal to 2 mm or more were not detected, and the gap 8 was confirmed to form between two adjacent structures 7.

As described above, the creepage distances X1 and X2 differ depending on which direction is the direction parallel to the first main surface 201. The direction parallel to the first main surface 201 is not limited as described above as long as the creepage distance X1 satisfies Formula (2) or the creepage distance X2 satisfies Formula (2). Even when the direction parallel to the first main surface 201 is not the positive x-axis direction or the positive y-axis direction, the creepage distance in this case may satisfy Formula (2).

Even when the laminate film 3 is placed under atmospheric pressure after being sealed, the first laminate film 31 is in close contact with the structures 7, but part of the first laminate film 31 is not in close contact with the power generating element 2 because of the gap 8 between adjacent two structures 7. In other words, the gap 8 formed between adjacent two structures 7 allows the first laminate film 31 to be peeled off more safely and efficiently from the battery 1 having the power generating element 2 enclosed in the laminate film 3.

### 4. Production Method

Next, a. method for producing the battery 1 according to this embodiment will be described. The method for producing the battery 1 described is illustrative only, and the method for producing the battery 1 is not limited to the following example.

First, the power generating element 2 is prepared. The power generating element 2 includes at least one battery cell 20. The battery cell 20 can be produced by a known method including, for example, laminating a positive electrode active material, a solid electrolyte, and a negative electrode active material on a current collector by coating or the like, The power generating element 2 including a plurality of battery cells 20 may be formed by laminating the battery cells 20 so as to establish series connection or parallel connection.

The protective plate 6 having the structures 7 is fixed above the battery cell 20 in the power generating element 2. In this case, the protective plate 6 on which the structures 7 are formed by using a mold may be used, or the protective plate 6 to which the structures 7 are attached may be used.

Next, the second laminate film 32 having, for example, a three-layer structure including a resin layer, an aluminum layer, and a resin layer laminated in this order is prepared in a vacuum chamber.

The power generating element 2 is disposed above the second laminate film 32, and the first laminate film 31 is disposed above the second laminate film 32, the power generating element 2, and the structures 7. In other words, the power generating element 2 and the structures 7 are sandwiched between and covered by two laminate films (first and second laminate films 31 and 32).

Next, a peripheral portion of the first laminate film 31 and a peripheral portion of the second laminate film 32 except part of the peripheral portions are bonded to each other by hot pressing to form the sealing part 5. Two laminate films are accordingly formed into a bag-shape laminate film. In the vacuum chamber, the pressure of the space outside the bag-shaped laminate film accommodating the power generating element 2 is reduced, and under a reduced pressure, non-pressure bonded portions are bonded to each other by hot pressing to seal the laminate film 3 storing the power generating element 2.

After sealing, the pressure inside the vacuum chamber is increased to atmospheric pressure to apply an external force, such as airflow or atmospheric pressure, so that the laminate film 3 comes into close contact with the power generating element 2. The battery 1 illustrated in FIG. 1 is produced accordingly.

### Modification 1 of First Embodiment

Next, a battery according to Modification 1 of the first embodiment will be described.

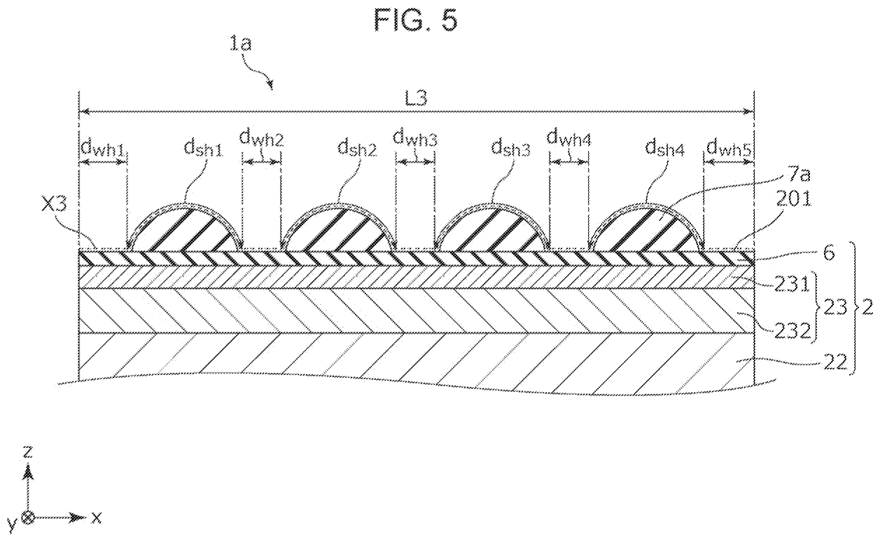

FIG. 5 is a cross-sectional view for describing one example of the relationship of a power generating element 2 and a plurality of structures 7a with the tensile elongation of a laminate film in a battery 1a according to Modification 1 of the first embodiment.

In Modification 1, the shape of the structures 7a differs from that of the first embodiment.

Specifically, the battery 1a has the same structure as the battery 1 according to the first embodiment except that each of the structures 7a of the battery 1a has a convex surface protruding toward a first laminate film (not shown). More specifically, each of the structures 7a has a semispherical shape. Accordingly, the first laminate film is, for example, in contact with the convex surface of each of the structures 7a. Thus, an excessive pressure is less likely to act on parts where the first laminate film is in contact with the structures 7a when the laminate film is sealed, which prevents breakage of the first laminate film. In other words, the battery 1a with high reliability is realized.

The shape of each of the structures 7a is not limited to the above shape and may be, for example, a spherical segment.

The relationship of the power generating element 2 and the structures 7a with the tensile elongation of the laminate film will be described by using a third example and a fourth example according to Modification 1. The creepage distance according to the third example is denoted by X3, and the creepage distance according to the fourth example is denoted by X4.

First, the creepage distance X3 according to the third example will be described with reference to FIG. 5. The creepage distance X3 is the creepage distance when the direction parallel to the first main surface 201 is the positive x-axis direction as in the first example. More specifically, in FIG. 5, the creepage distance X3 is the length along the broken line.

The length of the arc of each of the structures 7a illustrated in FIG. 5 is denoted by d_{sbn} (mm). The subscript n indicates the order of the structures 7a arranged in the positive x-axis direction. The width (length in x-axis direction) of regions in which the structures 7a are not located and that are positioned above the first main surface 201 is denoted by d_{whm} (mm). The subscript m indicates the order of the regions arranged in the positive x-axis direction. The length of the power generating element 2 in the positive x-axis direction according to the third example is denoted by L3. In this case, the creepage distance X3 satisfies Formula (5).

[Math. 5]

X3=Σₖ₌₁ⁿ(d_{s h k})+Σₖ₌₁^{m}(d_{w h k}) Formula (5)

For example, the length L3 of the power generating element 2 in the positive x-axis direction is 65 (mm), the radius of each of the structures 7a is 5 (mm), each of dₛₕₙ is 15.7 (mm) (the ratio of the circumference of a circle to its diameter is 3.14), each of d_{whm} is 5 (mm). As in the first embodiment, total 12 (4×3) structures 7, four structures 7 in the x-axis direction and three structures 7 in the y-axis direction, are provided, and the tensile elongation of the laminate film is 20%.

The creepage distance X1 in this case is 87.8 (mm) because the total dₛₕₙ is 62.8 (mm) and the total d_{whm} is 25 (mm). In the third example, the creepage distance X1 is calculated by using Formula (2). In this case, the value on the left side is 87.8 (mm), and the value on the right side is 78 (mm), which satisfies Formula (2). The size, shape, number, arrangement of the structures 7a are determined so as to satisfy Formula (2).

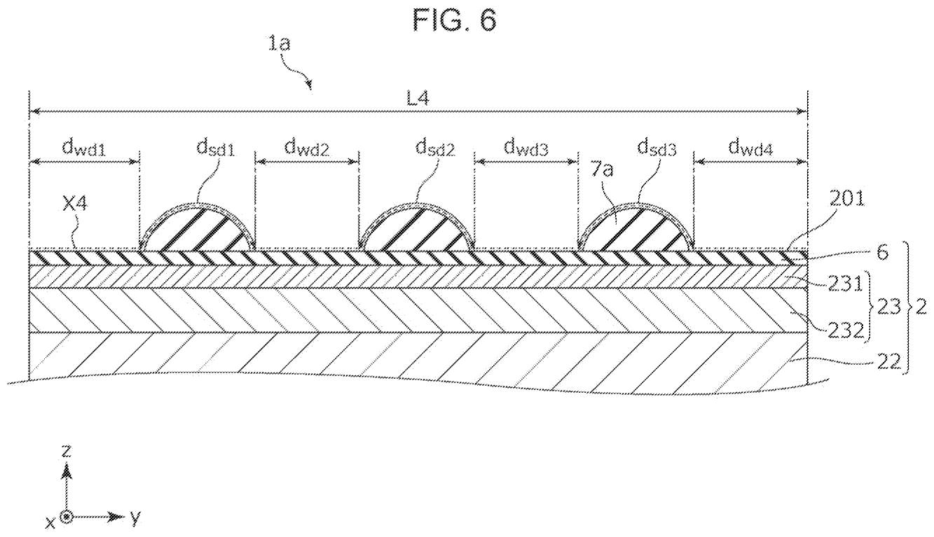

As described above, the direction parallel to the first main surface 201 is not limited to the positive x-axis direction and may be the positive y-axis direction. In the fourth example, the creepage distance X4 is the creepage distance when the direction parallel to the first main surface 201 is the positive y-axis direction. Next, the creepage distance X4 according to the fourth example will be described with reference to FIG. 6.

FIG. 6 is a cross-sectional view for describing another example of the relationship of the power generating element 2 and a plurality of the structures 7a with the tensile elongation of the laminate film in the battery 1a according to Modification 1 of the first embodiment.

In FIG. 6, the creepage distance X4 is the length along the broken line.

The length of the arc of each of the structures 7a illustrated in FIG. 6 is denoted by d_{sdp} (mm). The subscript p indicates the order of the structures 7a arranged in the positive y-axis direction. The width (length in y-axis direction) of regions in which the structures 7a are not located and that are positioned above the first main surface 201 is denoted by d_{wdq} (mm). The subscript q indicates the order of the regions arranged in the positive y-axis direction. The length of the power generating element 2 in the positive y-axis direction according to the fourth example is denoted by L4. In this case, the creepage distance X4 satisfies Formula (6).

[Math. 6]

X4=Σₖ₌₁^{p}(d_{s d k})+Σₖ₌₁^{q}(d_{w d k}) Formula (6)

For example, the length L4 of the power generating element 2 in the y-axis direction is 70 (mm), the radius of each of the structures 7a is 5(mm), each of (to is 15.7 (mm) (the ratio of the circumference of a circle to its diameter is 3.14), and each of d_{wdq} is 5 (mm). Three structures 7 are arranged in the y-axis direction as described above, and the tensile elongation of the laminate film 3 is 20%.

The creepage distance X4 in this case is 87.1 (mm) because the total d_{sdp} is 47.1 (mm) and the total d_{wdq} is 40 (mm). In the fourth example, the creepage distance X4 is calculated by using Formula (2). X in Formula (2) corresponds to X4, and L corresponds to L4. In this case, the value on the left side is 87.1 (mm), and the value on the right side is 84 (mm), which satisfies Formula (2). The size, shape, number, arrangement of the structures 7a are determined so as to satisfy Formula (2).

### Modification 2 of First Embodiment

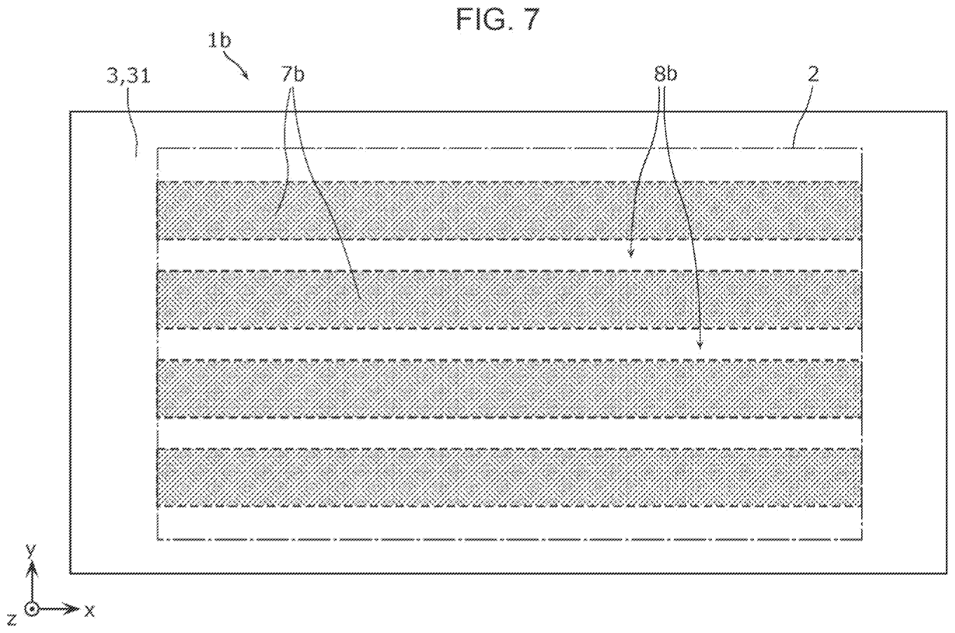

Next, a battery according to Modification 2 of the first embodiment will be described with reference to FIG. 7. FIG. 7 is a plan view of a battery 1b according to Modification 2 of the first embodiment.

In Modification 2, the shape of structures 7b differs from that in the first embodiment. Specifically, the battery 1b has the same structure as the battery 1 according to the first embodiment except that the structures 7a of the battery 1b are spaced apart from each other and arranged in a stripe pattern.

The structures 7b extend linearly in the x-axis direction, but the present disclosure is not limited to this. The structures 7b may extend linearly in a direction other than the x-axis direction as long as the structures 7b are each shaped so as to be in contact with and, along the first main surface 201. The structures 7b extend from a first end to a second end of the power generating element 2 (i.e., from an end portion of the power generating element 2 on the negative side in the x-axis direction to an end portion on the positive side in the x-axis direction) in plan view. However, the present disclosure is not limited to this configuration.

The shape of each of the structures 7b in the plane (yz plane) normal to the direction (x-axis direction) in which the structures 7b extend is a rectangle as in the first embodiment, but may be a semicircle as in Modification 1 of First Embodiment.

Since the structures 7b are spaced apart from each other, a gap 8b is located between adjacent two of the structures 7b. When the structures 7b are arranged in a stripe pattern in plan view, the gap 8b is also arranged so as to extend in a stripe pattern in plan view. In other words, the gap 8b having an elongated shape is disposed in Modification 2.

When part of the gap 8b is opened to the atmosphere at the time of peeling the first laminate film 31 off from the power generating element 2, the atmosphere enters the gap 8b, and the pressure of the entire gap 8b becomes equal to atmospheric pressure. The atmospheric pressure of the atmosphere entering the gap 8b presses the first laminate film 31, and the first laminate film 31 and the power generating element 2 are easily released from close contact with each other made under atmospheric pressure.

With the gap 8b configured in an elongated stripe pattern, the pressure in a wider range becomes equal to atmospheric pressure when part of the gap 8b is opened to the atmosphere. As a result, the first laminate film 31 is efficiently peeled off from the power generating element 2. In other words, the battery 1b from which the first laminate film 31 is peeled oft more efficiently can be provided.

### Second Embodiment

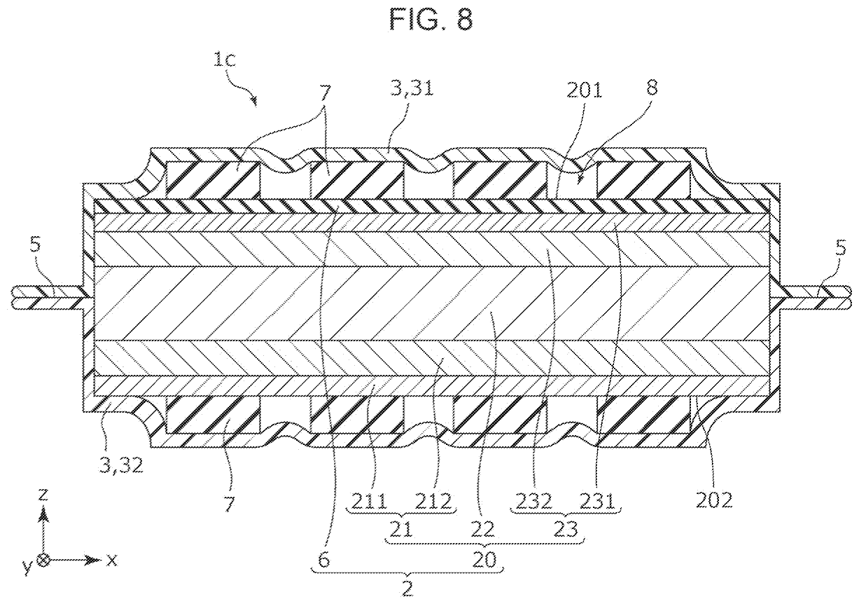

Next, a battery according to a second embodiment will be described with reference to FIG. 8. FIG. 8 is a cross-sectional view of a battery 1c according to the second embodiment.

The battery 1c according to this embodiment has the same structure as the battery 1 according to the first embodiment except that the battery 1c has a plurality of structures 7 on the second main surface 202 of the power generating element 2.

The second main surface 202. is a surface of the power generating element 2 opposite to the first main surface 201. The protective plate 6 is not disposed on the second. main surface 202 side in this embodiment, but the protective plate 6 may be disposed on the second main surface 202 side.

In this embodiment, the structures 7 are located between the first laminate film 31 and the first main surface 201 and between the second laminate film 32 and the second main surface 202. The gap 8 is located between the first main surface 201 and the first laminate film 31 and between the second main surface 202 and the second laminate film 32 such that the gap 8 is in contact with the structures 7. In this embodiment, the gap 8 is located between the structures 7.

The gaps 8 on both the first main surface 201 and the second main surface 202 suppress peeling electrification or triboelectrification when the first and second laminate films 31 and 32 are peeled off. The battery 1c from which the first and second laminate films 31 and 32 are safely peeled off is realized.

When the first and second laminate films 31 and 32 are peeled off from the power generating element 2, the atmospheric pressure of the atmosphere entering the gap 8 presses the first and second laminate films 31 and 32. As a result, the first and second laminate films 31 and 32 are easily released from close contact with the power generating element 2 under atmospheric pressure. As a result, the first and second laminate films 31 and 32 are efficiently peeled off from the power generating element 2.

In summary, the battery 1c from which the first and second laminate films 31 and 32 are peeled off safely and efficiently can be provided.

### Other Embodiments

The batteries according to one or more aspects are described above on the basis of the embodiments and modifications, but the present disclosure is not limited to these embodiments and modifications. Variations of embodiments and modifications that would be conceived by those skilled in the art, and forms constructed by combining components in different embodiments and modifications are also included in the present disclosure without departing from the gist of the present disclosure.

For example, in the battery 1 according to the first embodiment, the structures 7 all have the same shape. The present disclosure is not limited to this, and the structures 7 may have different shapes.

Various changes, substitutions, additions, omissions, and the like can be made to the embodiments described above within the scope of the claims or the range of their equivalency.

The battery according to the present disclosure can be used as a battery included. in, for example, vehicle batteries or various electronic devices.

What is claimed is:

1. A battery comprising:
a power generating element including a positive electrode layer, a negative electrode layer, and a solid electrolyte layer between the positive electrode layer and the negative electrode layer;
a structure located above a first main surface of the power generating element and having insulating properties; and.
a laminate film accommodating the power generating element and the structure;
wherein a gap is located between the first main surface and the laminate film such that the gap is in contact with the structure.

2. The battery according to claim 1, comprising:
a plurality of the structures,
wherein the gap is located between adjacent two of the structures.

3. The battery according to claim 2, wherein each of the structures has a rectangular parallelepiped shape.

4. The battery according to claim 2, wherein each of the structures has a convex surface protruding toward the laminate film.

5. The battery according to claim 2, wherein the structures are arranged in a matrix in a plan view of the power generating element.

6. The battery according to claim 2, wherein the structures are spaced apart from each other and arranged in a stripe pattern.

7. The battery according to claim 2, wherein the battery satisfies
X>L×(1+(Elf/100))
where X is a creepage distance that is a length along the first main surface and surfaces of the structures in a direction parallel to the first main surface,
L is a length of the power generating element in the direction, and
Elf is a tensile elongation of the laminate film.

8. The battery according to claim 1, wherein the solid electrolyte layer is a solid electrolyte layer containing a solid electrolyte having lithium-ion conductivity.

9. The battery according to claim 1, further comprising:
a plurality of structures on a second main surface of the power generating element opposite to the first main surface.
